(19) United States
(12) Patent Application Publication
(10) Pub. No.: US 2018/0179776 A1
(43) Pub. Date: Jun. 28, 2018

(54) STEEL TOWER FOR A WIND TURBINE AND A METHOD FOR MAKING THE TOWER

(71) Applicant: Nordex Energy GmbH, Hamburg (DE)

(72) Inventor: Ibrahim Tuerk, Hamburg (DE)

(21) Appl. No.: 15/853,217

(22) Filed: Dec. 22, 2017

(30) Foreign Application Priority Data
Dec. 22, 2016 (EP) 16206088.3

(51) Int. Cl. E04H 12/08; E04H 12/34; F03D 13/20

(52) U.S. Cl. CPC E04H 12/085; E04H 12/342; F05B 2280/1071; F05B 2230/61; F05B 2230/10; F03D 13/20

(57) ABSTRACT

A method for making a tower for a wind turbine includes: making tower sections, which can be arranged one on top of another; defining two separation lines running in a longitudinal direction for one of the tower sections and providing a longitudinal profile for a separation line, wherein the profile is formed as a single piece with two legs running parallel at a mutual distance; connecting the profile to the tower section, wherein the legs are connected to the tower section on opposing separation line sides; severing the tower section along the separation line into segments mutually separated by a segment boundary, wherein the monolithic profile is severed and each of the legs remains connected to a segment on a different side of the boundary; connecting segments by the legs of the severed profile to a tower section; and, connecting several tower sections to form a tower.

### CROSS REFERENCE TO RELATED APPLICATION

This application claims priority of European patent application no. 16 206 088.3, filed Dec. 22, 2016, the entire content of which is incorporated herein by reference.

### FIELD OF THE INVENTION

The invention relates to a steel tower for a wind turbine, including a plurality of tower sections arranged one above another and joined together, of which at least one tower section includes section segments joined together. The invention likewise relates to a method for making such a steel tower.

### BACKGROUND OF THE INVENTION

With the increasing demand for wind turbines of higher power and thus larger dimensions of the main components, such as tower, nacelle, and rotor blades, the permissible limits for vehicle dimensions have been reached, especially the maximum height of around 4 meters. The boundaries dictated by the logistical infrastructure, such as clear height under bridges, also make it necessary to divide tower sections with more than roughly 4 meters diameter into several pieces.

The utility model DE 203 21 855 U1 describes a steel tower for a wind turbine comprising a number of cylindrical or conical tower sections, where at least its broader sections are subdivided into two or more elongated shell segments which are combined into a complete tower section via vertical flanges, which are fastened to each other by a plurality of bolts, the shells also being provided with upper and lower horizontal flanges in order to allow the tower sections to be connected to each other.

U.S. 2008/0256892 shows a wind turbine tower with a load-bearing outer tower wall, having an encircling outer boundary surface and a plurality of wall sections, each of which has a middle section and two edge sections running in the longitudinal direction of the tower, being provided with a plurality of connection boreholes, while the surfaces defined by the edge sections run along the outer boundary surface or at a constant distance from it, and the connection boreholes are oriented transversely to the outer boundary surface.

From U.S. Pat. No. 9,091,095 and U.S. Pat. No. 9,243,418 there is known a tower with an adapter piece as well as a method of making a tower, wherein a lower tubular tower section of concrete and an upper tubular tower section of steel are provided. Such hybrid towers are preferred at present for the erecting of especially tall wind turbine towers, since large diameters are possible with the lower concrete structure and conventional steel tubular tower sections can be set atop the lower tower structure in order to achieve greater heights and thus better wind utilization.

From U.S. 2017/0122292 there is known a method for making a tower section for the tower of a wind turbine in which the tower section is subdivided into section segments in the tower lengthwise direction. The section segments are at first created by severing the tower wall and afterwards joined to each other once more with the aid of flanges.

### SUMMARY OF THE INVENTION

It is an object of the invention to provide a steel tower for a wind turbine as well as a method for making it, making it possible to produce precisely a tower section connected from segmented tower sections with simple means.

The object can, for example, be achieved by a steel tower for a wind turbine, wherein the steel tower defines a longitudinal tower direction and a circumferential direction. The steel tower includes: a plurality of tower sections in the longitudinal direction; each of the tower sections being either conical or cylindrical; at least one of the tower sections being divided in the circumferential direction into at least two section segments; each two mutually adjacent ones of the section segments defining a segment boundary therebetween; a longitudinal profile extending in the longitudinal tower direction; two mutually adjacent ones of the section segments being joined together by portions of the longitudinal profile; the longitudinal profile including two legs; each of the two mutually adjacent ones of the section segments having one of the legs of the longitudinal profile fastened thereto; the legs of the two mutually adjacent ones of the section segments being joined to each other across the segment boundary corresponding thereto; each of the legs of the two mutually adjacent ones of the section segments being arranged on a different side of the segment boundary corresponding thereto; each of the legs of the two mutually adjacent ones of the section segments including a web section extending up to the respective segment boundary; and, the web sections and the legs of the longitudinal profile forming a monolithic longitudinal profile prior to a severing of the two mutually adjacent ones of the section segments.

The steel tower according to an embodiment of the invention, especially a tubular steel tower for a wind turbine, includes a plurality of cylindrical and/or conical tower sections which are joined together preferably via horizontal annular flanges and/or annular flange segments. At least one tower section is divided into several, preferably three section segments, which are joined together each via longitudinal profiles having a plurality of through holes and by connection means to form a complete tower section. The vertically attached longitudinal profiles have at least two preferably plane parallel legs as well as a web connecting the legs. The monolithic longitudinal profile is welded on either side to the inside of the wall of the tower section. The monolithic longitudinal profile is severed together with the tower wall in the longitudinal direction, preferably down the middle, wherein the web of the monolithic longitudinal profile is also divided. The web sections formed by the severing of the longitudinal profile preferably have separation sections on their mutually facing sides, which were formed by the severing. However, the tower sections according to the invention are not limited to two or three section segments, but instead also encompass tower sections having four or more section segments.

The object can, for example, also be achieved by a steel tower for a wind turbine, wherein the steel tower defines a longitudinal tower direction and a circumferential direction. The steel tower includes: a plurality of tower sections in the longitudinal direction; each of the tower sections being either conical or cylindrical; at least one of the tower sections being divided in the circumferential direction into two or more section segments; each two mutually adjacent ones of the section segments defining a segment boundary therebetween; a longitudinal profile extending in the longitudinal tower direction; two mutually adjacent ones of the section segments being joined together by portions of the longitudinal profile; the longitudinal profile including two legs; each of the two mutually adjacent ones of the section segments having one of the legs of the longitudinal profile fastened thereto; each of the legs of the two mutually adjacent ones of the section segments being arranged on a different side of the segment boundary corresponding thereto; each of the legs of the two mutually adjacent ones of the section segments having a separation section directed toward the segment boundary corresponding thereto on their mutually facing sides; and, the legs with the separation sections forming a monolithic longitudinal profile prior to a severing of the two mutually adjacent ones of the section segments.

One difference to the embodiment described above lies in the configuration of the longitudinal profile after the severing. The severed longitudinal profile does not have two mutually facing web sections, but instead separation sections on the mutually facing sides of the legs. The longitudinal profiles in both embodiments of the invention have two legs before and after the severing.

According to an aspect of the invention, the object can, for example, also be achieved via a method for the making of a tubular steel tower for a wind turbine, in which tower wall and longitudinal profile are severed together during a separation process along a segment boundary. The method includes: making several tower sections, which can be arranged one on top of another in a longitudinal tower direction, each of the several tower sections being either conical or cylindrical; defining at least two planned separation lines running in the longitudinal tower direction for one of the tower sections and providing a longitudinal profile for the planned separation line, having two legs running parallel and at a distance from each other, wherein the longitudinal profile is formed as a single piece with its legs so as to form a monolithic longitudinal profile; connecting the longitudinal profile to the tower section, wherein the legs are connected to the tower section on opposite sides of the separation line; severing the tower section along the separation line into section segments separated from each other by a segment boundary, wherein the monolithic longitudinal profile is also severed and each of the legs remains connected to a section segment on a different side of the segment boundary; connecting two or more section segments by the legs of the severed longitudinal profile to a tower section; and, connecting several tower sections in the longitudinal tower direction to form a steel tower.

In an advantageous embodiment of the invention, the tower section has at least two section pieces, which are welded together along their adjacent horizontal annular end faces and are welded to horizontal annular flanges along the free uppermost and lowermost end face, the annular flanges being divisible at predetermined positions into at least two, preferably three or more annular flange segments. The annular flanges possess a plurality of through holes for connection means, such as screws, threaded bolts and threaded rods.

Each section segment of a tower section has at least one annular flange segment at its upper and lower end face. The arc length of the lower annular flange segment is greater than or less than or the same as the arc length of the upper annular flange segment, and the annular flange segments possess a plurality of through holes for connection means such as threaded bolts or the like.

In one advantageous embodiment of the invention, the monolithic longitudinal profiles are preferably fashioned as equilateral U-profiles, H-profiles, C-profiles, I-profiles, cap profiles or double-T profiles. The use of double-leg profiles with a joining web offers considerable advantages over two flat iron pieces welded together, since on the whole fewer individual parts need to be manipulated. The longitudinal profile already has plane parallel legs, which is also preserved in the severing process.

In one advantageous embodiment of the longitudinal profile, its webs each have a U or V-shaped fillet at the tower wall side, extending in the longitudinal direction. This fillet performs two functions, in particular: on the one hand, there is achieved an advantageous cross section and thus material reduction for a subsequent lengthwise cutting, and on the other hand a fillet is created on either side of the separation line for a welded seam for the sealing of any gap created after a lengthwise cutting.

The web sections remaining on either side of the fillet form secure bearing surfaces, especially surfaces free of tilting, for the inner side of the tower wall. For further improvement of the welding process, the vertically arranged longitudinal profiles each time have a bevel in the longitudinal direction at the outwardly facing transitions from the legs to the right-angled web for making a welded seam.

A preferred connection of a longitudinal profile of a first kind, especially one in the form of a U, C, or cap profile, to the tubular wall of the tower section is accomplished in that, for example, the longitudinal profile is welded on with its web facing the inside of the wall of a tower section. In the case of a C profile open toward the top, whose two inwardly curved right-angled prolongations of the legs are facing each other and whose spacing basically corresponds to the width of the slot in the web, one has the further advantage that no spacing elements are needed during a later installation of the section segments, since the mentioned prolongations are drawn toward each other and thus perform the function of the spacing elements, thereby producing an advantageous reduction in the installation time at the construction site.

A preferred arrangement for the connecting of a second kind of longitudinal profile, especially in the form of H, I, or double T profiles, but also U, C, or cap profiles, to the tubular wall of the tower section, is accomplished in that the longitudinal profiles are welded on with their web facing the inside of the wall of a tower section. When using a H profile open toward the top, in which the web is at a distance from the inside of the wall of a tower section, the width of the slot in the web can advantageously be chosen such that no spacing elements are needed during a later installation of the section segments, since the end faces of the web are drawn toward each other and thus perform the function of the spacing elements, thereby producing an advantageous reduction in the installation time at the construction site.

It has been found to be advantageous for the length of the parallel and spaced apart longitudinal profiles of a section piece to be greater than the length of the section piece itself, because then the horizontal welded seams of the connection of the section pieces can be bridged over.

A tubular steel tower according to the invention affords time savings and economic savings for present and future towers with a large diameter, and in particular wind turbines with tubular steel towers according to the invention are available more quickly for energy production. One time-saving aspect in the use of section segments is that these can advisedly be provided with built-in elements in the form of components for an access system, conductor sections, cable holding devices, busbars and/or other built-in elements running in the longitudinal direction of the tower or the section segments, before the section segments are transported to the installation site. A further benefit of the section segments is that these can be more easily surface coated and/or varnished, especially with smaller coating installations, before being transported to the installation site.

In one advantageous way of carrying out the method, for a further machining the tower section is placed via a hoist or an industrial truck above at least one movable cutting device and set down on supporting means of a lifting device such that the first planned axial separation line is in a 6 o'clock position, that is, facing downward. According to the 6 and 12 o'clock positions on a watch dial, the 6 o'clock position denotes the lowest and the 12 o'clock position the highest position. The tubular body not yet completed with the annular flanges to form the tower section can also be machined accordingly.

Furthermore, the method preferably involves welding a closed annular flange in a predetermined position with regard to the circumferential direction onto the ring shaped end faces of the tubular body or a section piece in order to form a tower section, the annular flanges having partial sections with a reduced cross section in predetermined positions and the partial sections coinciding with the planned separation lines or being flush with them. After the severing, the separation lines form the segment boundaries and the annular flange consists of annular flange segments.

In one especially preferred procedure of the method, in the following step the annular flanges of the tower section are connected, in particular bolted, at the end face to movable or moving devices, the devices being preferably configured as rotatable receiving wheels or rotatable frames. By means of these devices, a tower section can be rotated in an especially gentle manner, that is, without leaving marks by rollers on the outer sheath of the tubular body, such as might occur with the use of roller beds.

In another especially preferred procedure of the method, with a further step the tower section or the tubular body is placed via a hoist or an industrial truck onto two or more beams running parallel to each other, the tower section being positioned such that the first planned axial separation line runs substantially down the middle between the parallel beams in the 6 o'clock position. The beams belong to a supporting device, on which the tower section lies and which prevents a buckling of the tower section.

With another following step of the method, the at least one movable cutting device is moved into a starting position near a first annular flange and then in a further step the cutting tool, especially a side milling cutter or a saw blade, under rotation, is brought into contact via a vertically movable tool holder with the first annular flange at the first predetermined position.

In one especially preferred procedure of the method, with the following step the first annular flange is severed via the cutting tool at the first predetermined position with reduced cross section and in an immediately following step the cutting tool is moved continuously along the first axial separation line through the tubular wall as well as the web of the longitudinal profile connected to the tubular wall. Preferably, the direction of rotation of the cutting tool is chosen such that the resulting shavings are taken away downward. The cutting tool is further moved continuously along the first axial separation line through the tubular wall as well as the web of the longitudinal profile connected to it and finally through the second annular flange. After this, the cutting tool is moved back to its starting position. With the method it is possible to automatically perform the cutting process over the entire length of the tower section, especially without a manual repositioning of a cutting device.

After completing the first lengthwise cut through the tower section, the method preferably involves steps for making additional lengthwise cuts, at first performing a rotation of the tower section about its longitudinal axis, for example, by 120°, preferably via the rotatable receiving wheels, so that the second planned axial separation line is positioned at the 6 o'clock position.

After this, with the following steps additional lengthwise cuts are made with the cutting tool. Specifically, the steps for this involve: severing the first annular flange at the second predetermined partial section. Immediately after this, the cutting tool is moved continuously along the second axial separation line through the tubular wall and the web of the longitudinal profile. Finally, the second annular flange is severed at the second predetermined partial section.

Then there occurs a further rotation of the tower section about its longitudinal axis, preferably via the rotatable receiving wheels, for example, by a further 120°, until the first section segment which has been cut free is positioned substantially in the middle in the 12 o'clock position. Then comes the connecting of the section segment to the slings of a hoist, the moving of the section segment via the hoist and/or the positioning means of the receiving wheels on the outside radially, the releasing of the section segment from the receiving wheels, the lifting of the section segment and setting it down on a transportation trailer via the hoist, the hauling away of the section segment, preferably to a following processing installation, especially a coating and/or varnishing installation.

### BRIEF DESCRIPTION OF THE DRAWINGS

The invention will now be described with reference to the drawings wherein:

FIG. 1 shows an overall perspective view of a wind turbine;

FIG. 2 shows a perspective view of a tower section according to the invention;

FIG. 3A shows a cross section view of a vertical longitudinal profile of a first embodiment in a first production phase;

FIG. 3B shows a cross section view of the vertical longitudinal profile in FIG. 3A in a second production phase;

FIG. 3C shows a cross section view of the vertical longitudinal profile in FIG. 3A in a third production phase;

FIG. 4A shows a cross section view of a vertical longitudinal profile of a second embodiment in a first production phase; FIG. 4B shows a cross section view of a vertical longitudinal profile in FIG. 4A in a second production phase;

FIG. 4C shows a cross section view of a vertical longitudinal profile in FIG. 4A in a third production phase;

FIG. 5 shows a cross section view of a vertical longitudinal profile in a third embodiment;

FIG. 6 shows a top view of a T-annular flange;

FIG. 7 shows a magnified cutout of the T-annular flange of FIG. 6;

FIG. 8 shows a cross section view of the T-annular flange of FIG. 6;

FIG. 9 shows a magnified cutout of an L-annular flange;

FIG. 10 shows a cross section view of the L-annular flange of FIG. 9;

FIG. 11 shows a magnified cutout of an L-annular flange and an adapter plate;

FIG. 12 shows a cross section view of the L-annular flange and the adapter plate of FIG. 11;

FIG. 13 shows an overall perspective view of a tower section in a machining station;

FIG. 14 shows a perspective view of a cutting device; and,

FIGS. 15A to 15C show a cross section view of a vertical longitudinal profile in an embodiment with no web in three different production phases.

### DESCRIPTION OF THE PREFERRED EMBODIMENTS OF THE INVENTION

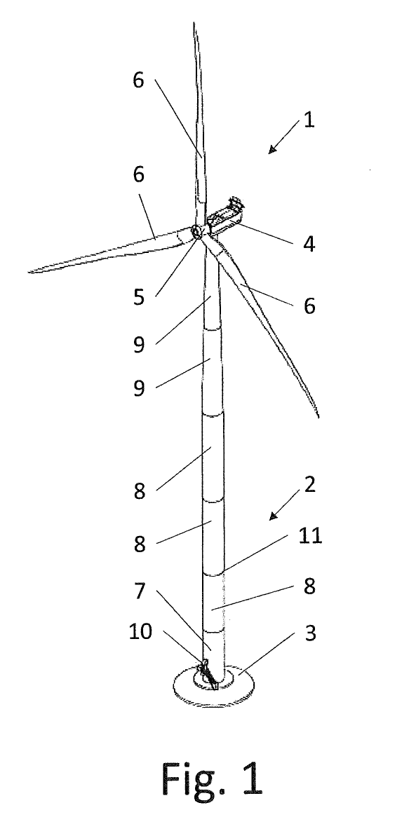

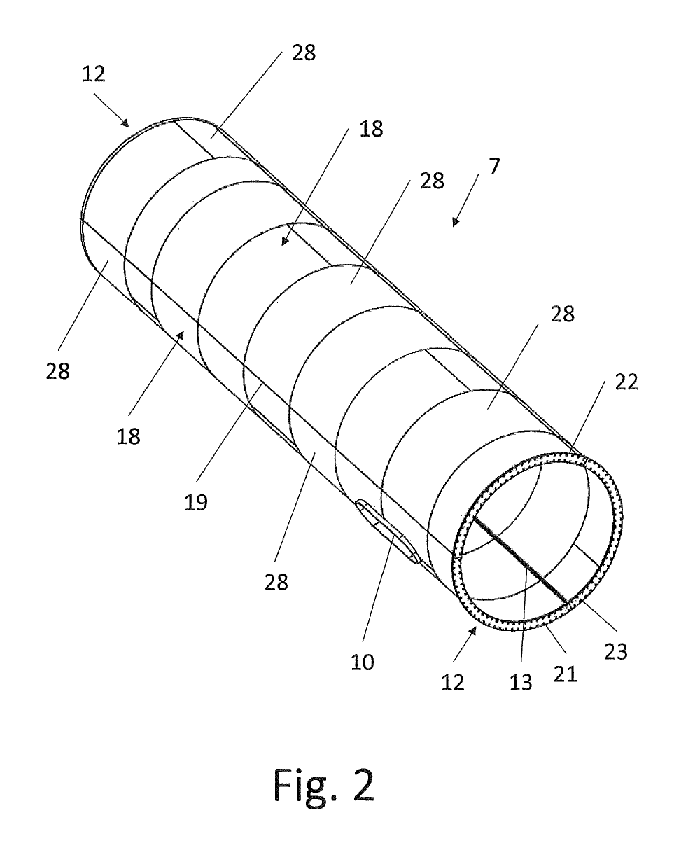

FIG. 1 shows a wind turbine 1 with a tower, which is constructed as a tubular steel tower 2 from a number of equal and different tower sections 7, 8, 9, wherein the lowermost tower section 7 is shown in detail in FIG. 2. The tubular steel tower 2 carries a nacelle 4 which is mounted so as to be able to rotate about a vertical longitudinal axis of the tower. In the nacelle 4 is mounted a drive train (not shown) with a main shaft, a gearing, and a generator. The main shaft stands in operative connection with a rotor hub 5, on which three rotor blades 6 are mounted so as to be able to rotate about their longitudinal axis. The tubular steel tower 2 besides the lowermost tower section 7 includes further tower sections 8, 9, where the lower tower sections 7, 8, that is, those with larger diameter, include detachably joined section segments 18, while the upper tower sections 9, that is, those with smaller diameter, are configured as monolithic sections in the circumferential direction.

FIG. 2 shows the lower tower section 7 with the tower entrance door opening 10. The prefabricated tower section 7 includes a number of section pieces 28, also known as “rounds” or “cans” among experts. The section pieces 28 generally have a lengthwise welded seam due to the manufacturing process. Other tower sections 8, without tower entrance door opening 10, are constructed accordingly, the number of section pieces 28 possibly varying. In the sample embodiment shown, the tower section 7 has in total nine section pieces 28, which are welded to each other at their end faces. The free end faces of the outermost section pieces 28 of a section are each welded to an annular flange 12. In an advantageous modification, not shown, the annular flanges 12 are each welded beforehand to a perpendicularly disposed section piece 28 before being welded to the other section pieces 28. It is known to weld individual annular flange segments, instead of closed annular flanges, to the free end faces of the outermost section pieces of a tower section, although this requires an additional effort for the orientation work.

As can furthermore be noticed in FIG. 2, the individual section pieces 28 can be rotated relative to each other about their lengthwise axis such that their longitudinal welded seams are always offset from each other by an offset angle so that the longitudinal welded seams of neighboring section pieces 28 do not lie flush in the same line. The sum of the offset angles is preferably 360° or a whole multiple thereof. FIG. 2 moreover shows a first longitudinal profile 13 roughly in the 5 o'clock position, which extends on the inside of the wall of the tower section 7 parallel to its center axis and is welded to the wall. Besides the longitudinal profile 13 shown, the tower section 7 has two more longitudinal profiles 13, not visible from the outside, arranged each at a 120° offset in the tubular wall. In a following fabrication step, the tower section 7 is divided along a first, second and third planned separation line 19 into three section segments 18, the planned separation lines 19 each coinciding with the longitudinal profiles 13. In other words, the respective lengthwise cutting occurs through the longitudinal profile 13, so that the section segments can afterwards be joined together once more by the longitudinal profile.

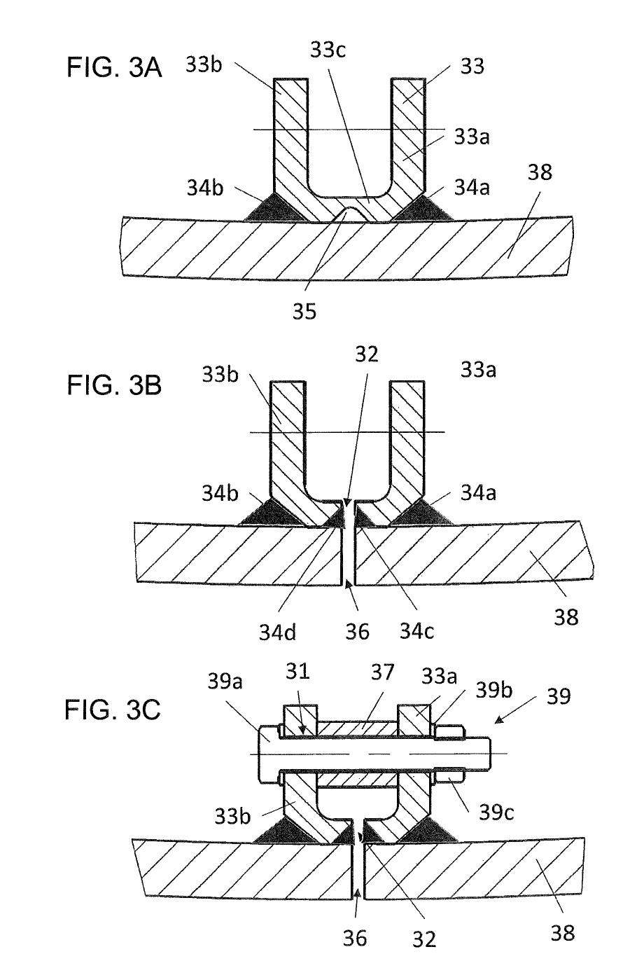

FIGS. 3A to 3C show one possible longitudinal profile 13 in the form of a U profile 33, having equally long, plane parallel legs 33a, 33b and a web 33c joining the legs together, in three consecutive fabrication steps. The U profile 33 at first is welded by its web 33c on either side by the welded seams 34a and 34b to the as yet undivided tubular wall 38, only a cutout of the tubular wall 38 being shown. The web 33c furthermore has on the side facing the tubular wall 38 a fillet 35, which has two purposes: first of all, an advantageous cross section and thus material reduction is achieved for a following lengthwise cutting, wherein a first slot 36 is created in the tubular wall 38 of the tower section 7, 8 and a second slot 32 in the web 33c of the U profile 33, cf. FIG. 3B. The slots 36 and 32 are preferably produced in a common separation process. Each of the slots 32, 36 after the severing has a pair of mutually facing separation sections in which the separation occurred. Secondly, a fillet is created on either side of the slot edge for a further welded seam 34c, 34d on each side. In the course of the installation at the construction site, the section segments 18 are finally connected securely via connection means 39, especially threaded bolts 39a, which are passed through through holes 31 in the legs 33a, 33b of the severed longitudinal profile, and nuts 39c. Spacing elements 37 ensure a predetermined spacing and the slot widths 32, 36, as shown by FIG. 3C. Thus, a desired slot width 32, 36 can be advantageously adjusted with the length of the spacing elements 37.

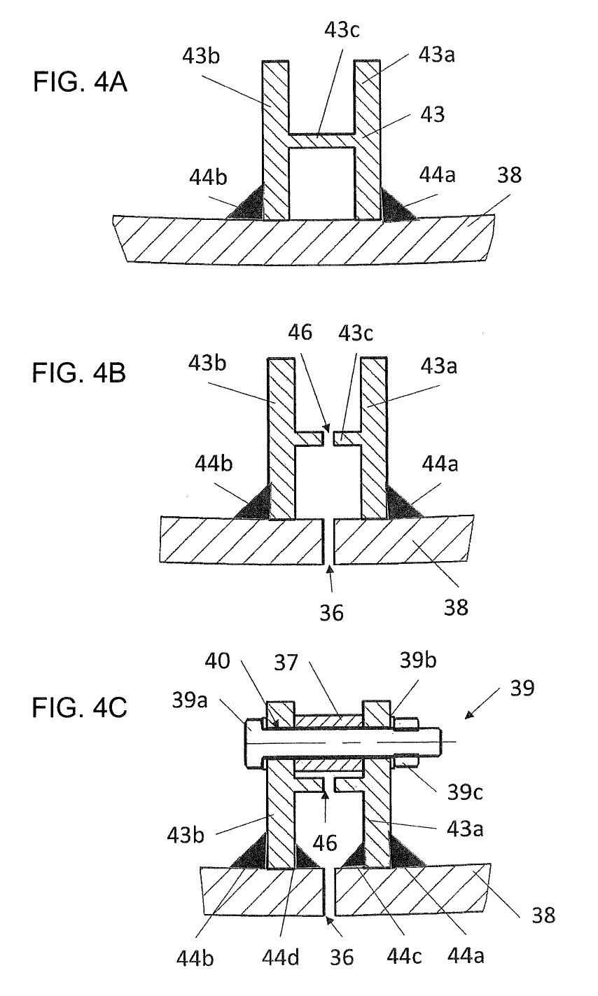

FIGS. 4A to 4C show another arrangement of longitudinal profile 13 and tubular wall 38. The longitudinal profile 13 here is fashioned in the form of a H profile 43, having equally long and plane parallel legs 43a, 43b and a web 43c. The H profile 43 is at first welded by its legs 43a, 43b on either side by the welded seams 44a and 44b to the as yet undivided tubular wall 38. FIG. 4B shows the arrangement having the longitudinal profile 13 and the tubular wall 38 after a lengthwise cut has been made, wherein a first slot 36 was created in the tubular wall 38 of the tower section 7, 8 and a second slot 46 in the web 43c of the H profile 43. FIG. 4C finally shows the threaded bolts 39a, nuts 39c and spacing elements 37 led through through holes 40 of the legs 43a, 43b in the course of the installation at the construction site and the thus securely connected section segments 18, once again only showing a cutout of the tubular wall 38.

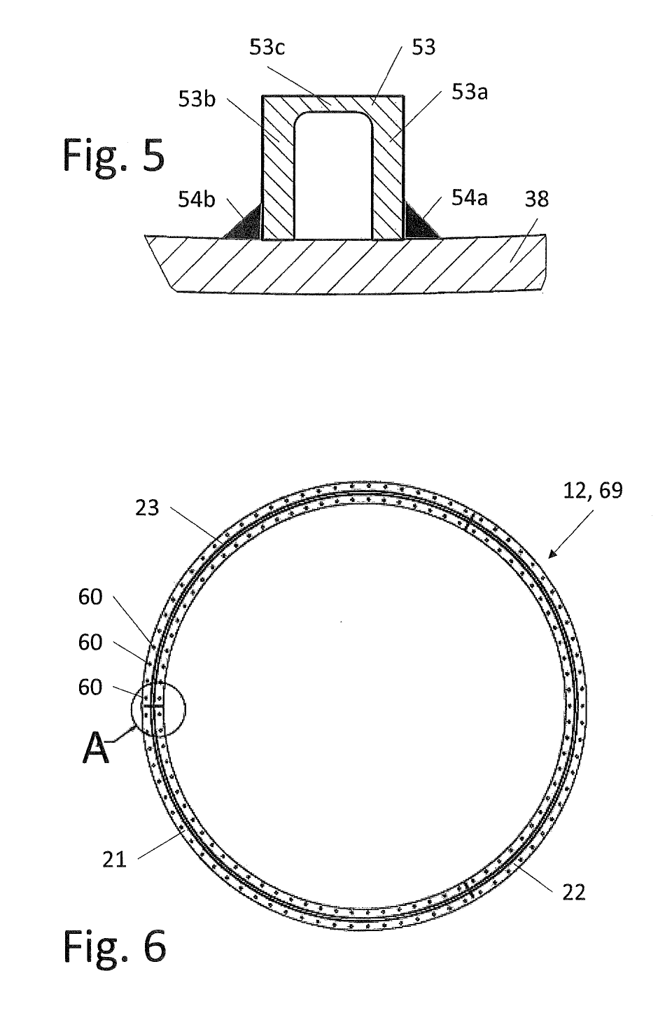

FIG. 5 shows a longitudinal profile 13 in the form of another U profile 53, but one which has been rotated about its longitudinal axis by 180° as compared to the arrangement in FIGS. 3A to 3C. The U profile 53 contrary to the sample embodiment of FIGS. 3A to 3C has been welded by the legs 53a, 53b via the welded seams 54a and 54b to the as yet undivided tubular wall 38. The further fabrication steps are essentially as represented and described in FIGS. 4B and 4C.

Another advantageous arrangement, not shown, has in place of a U profile 33 per FIGS. 3A to 3C a C profile open on top. The C profile by contrast with the U profile 33 has two inwardly curved right-angle prolongations of the legs, the open end surfaces of these prolongations facing each other and their spacing corresponding substantially to the width of the slot in the web. The C profile has the further advantage that the spacing elements 37 are not needed during a later installation of the section segments 18, since the mentioned prolongations are drawn toward each other and thus take on the function of the spacing elements 37, achieving an advantageous reduction in the installation time.

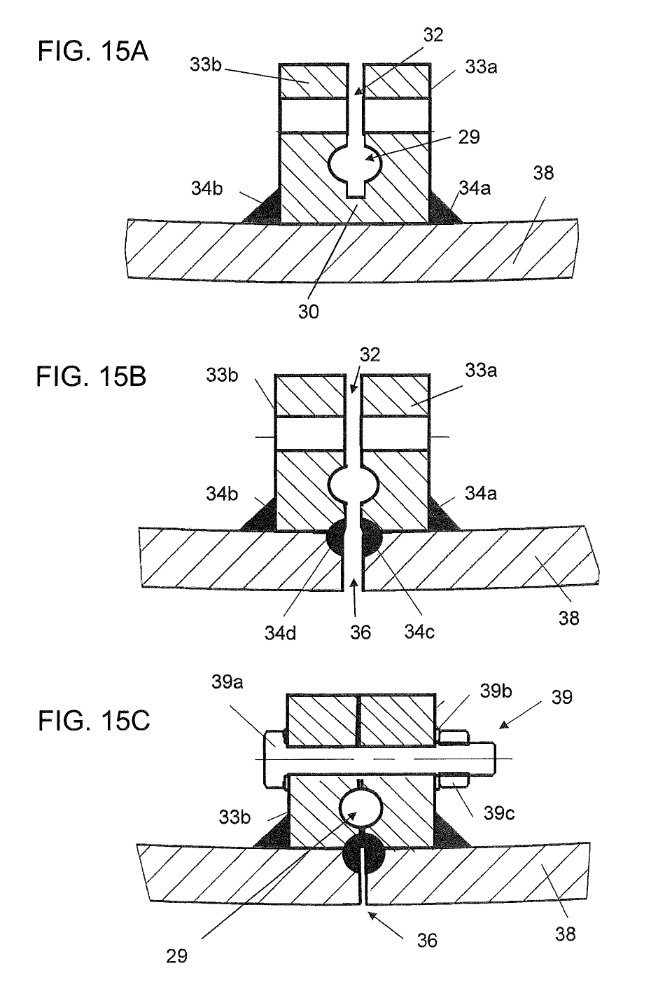

Besides the above profiles of FIGS. 3A to 3C, 4A to 4C and 5, having a web which joins the legs together, FIGS. 15A to 15C show a longitudinal profile 30 which is welded by two lateral welded seams 34a, 34b to the tubular wall. The longitudinal profile 30 has two legs 33a, 33b, which are separated from each other by a groove 32. The groove 32 has a groove bottom in the longitudinal profile 30. In the groove there is provided a borehole 29, which extends in the longitudinal direction of the longitudinal profile 30. Upon severing the tower wall 38 in the region 36, the groove bottom is also severed and the two legs 33a, 33b are independent of each other. Since the width of the separating slot in the region 36 is larger than the groove width 32, the legs remain behind without web sections. Instead, these have separation sections on the mutually facing sides of the legs, which are formed by the severing of the tower wall and the longitudinal profile. The legs 33a, 33b are connected by welding at their mutually facing sides to the tower wall 38. If the severed section segments are supposed to be joined together once more with the aid of the severed longitudinal profile 30, an orientation can be done by a centering pin in the borehole 29. Thanks to the centering pin, the legs 33a, 33b are oriented relative to each other and can thus be fastened to each other by the threaded bolt 39a, the washer 39b and the nut 39c.

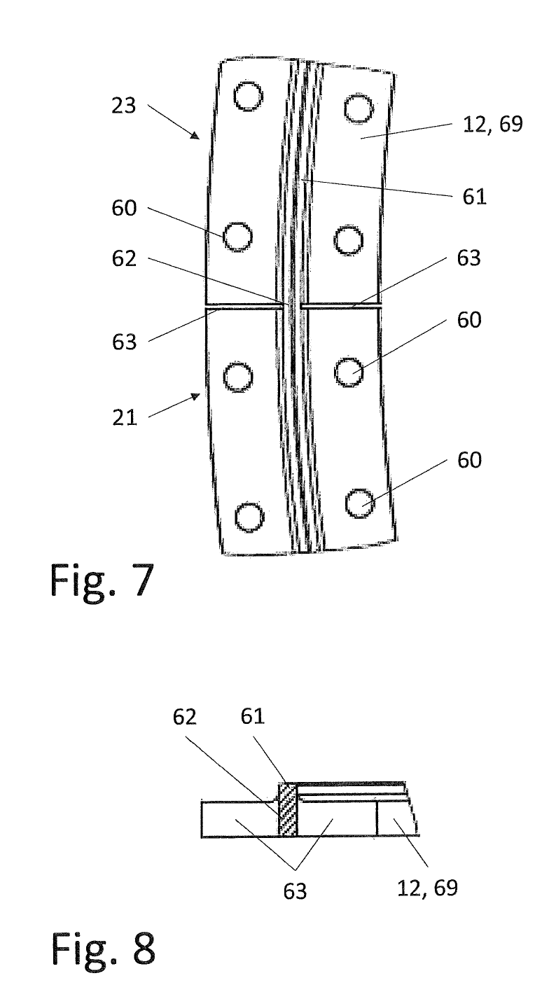

FIG. 6 shows a top view of an annular flange 12 with an indicated detail “A”. FIG. 7 shows an enlarged cutout and FIG. 8 a cross section view of detail “A”. The annular flange per FIGS. 6, 7 and 8 is configured as a T-annular flange 69, which is intended to attach the lowermost tower section 7 to the foundation 3 and its projecting anchor bolts (not shown). The T-annular flange 69 has separation sections with reduced material thickness at predetermined positions, where the annular flange can be divided into three annular flange segments 21, 22, 23. At each predetermined position of a separation section, the cross section of the T-annular flange 69 is reduced by two slots 63, so that only a narrow segment connection 62 remains. This segment connection 62 will be severed later in the fabrication process, namely, only after the welding of the T-annular flange 69 to a section piece 28 of the tower section 7. Furthermore, the T-annular flange 69 has a plurality of through holes 60, which are arranged on either side of the web 61 in two concentric circles of holes.

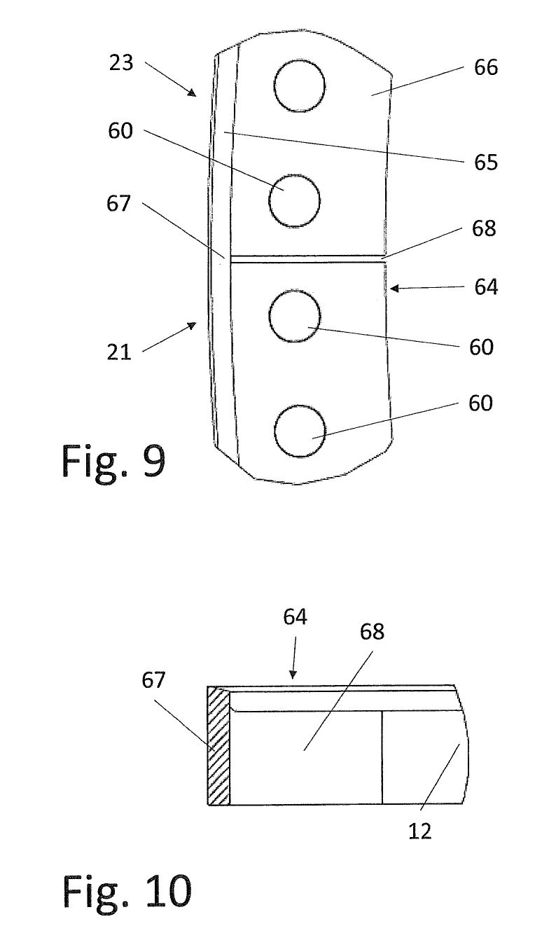

For the connecting of the tower sections 7, 8, 9 to each other, annular flanges 12 are provided in the form of L-annular flanges 64, having two legs 65, 66 arranged at right angles to each other, as shown in FIGS. 9 and 10. The first leg 65, pointing out from the plane of the drawing in FIG. 9, is butt welded to a section piece 28 of the tower section 7, 8 and thus forms a section of the outer shell of the tower section 7, 8. The second leg 66, directed inward in the plane of the drawing, has a plurality of through holes 60 for connection means 39, in order to connect the L-annular flange 64 to the adjoining L-annular flange 64 of an adjoining tower section 7, 8. Thus, the two L-annular flanges 64 form a pair of annular flanges. As can be seen again in FIGS. 9 and 10, the L-annular flange 64 is provided with separation sections at predetermined positions, where the annular flange can be divided into three annular flange segments 21, 22, 23. At the predetermined position of the separation sections the cross section of the L-annular flange 64 is reduced by a slot 68, so that a narrow segment connection 67 exists. This segment connection 67 will be severed later in the fabrication process after the welding of the L-annular flange 64 to a section piece 28. The segment connection 67 forms the separation section for the L-annular flange 64.

The choice of the connection means 39 is not limited to threaded bolts 39a, washers 39b and nuts 39c, but rather many other connection means are likewise suitable, especially screw connections such as threaded rods with nuts provided on both sides, threaded sleeves with threaded bolts provided at both sides, et cetera.

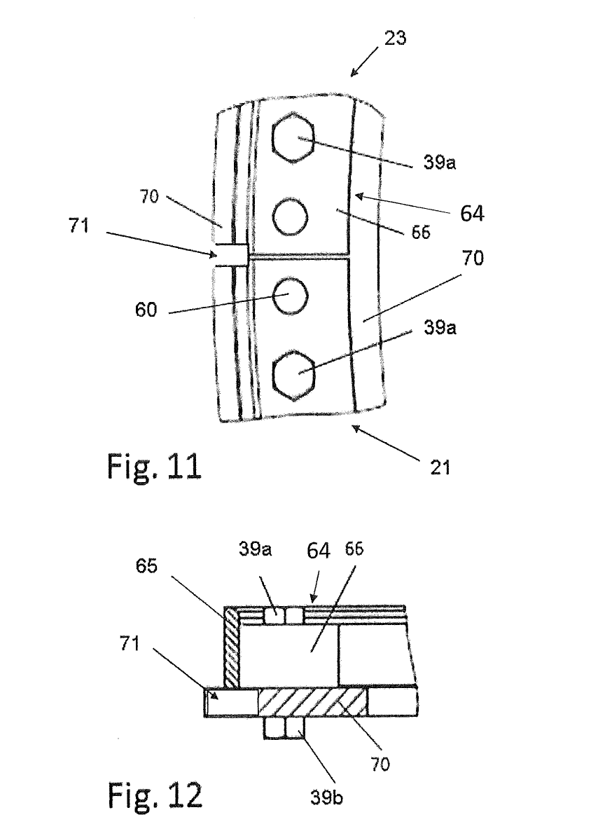

FIG. 11 shows a top view and FIG. 12 a cross section view of a cutout of an adapter plate 70 mounted on an L-annular flange 64 of a tower section, serving for the connecting or supporting of the tower section during a further processing and especially during a severing of the tower section. The L-annular flange 64 is connected to the adapter plate 70 by a screw connection including threaded bolts 39a and nuts 39c. The adapter plate 70 has a one-sided slot 71 for the passage of a cutting tool 99. After a severing of the segment connection 67 in the separation section, the annular flange segments 21, 22, 23 remain connected with the adapter plate 70 and are thus fixed in their position.

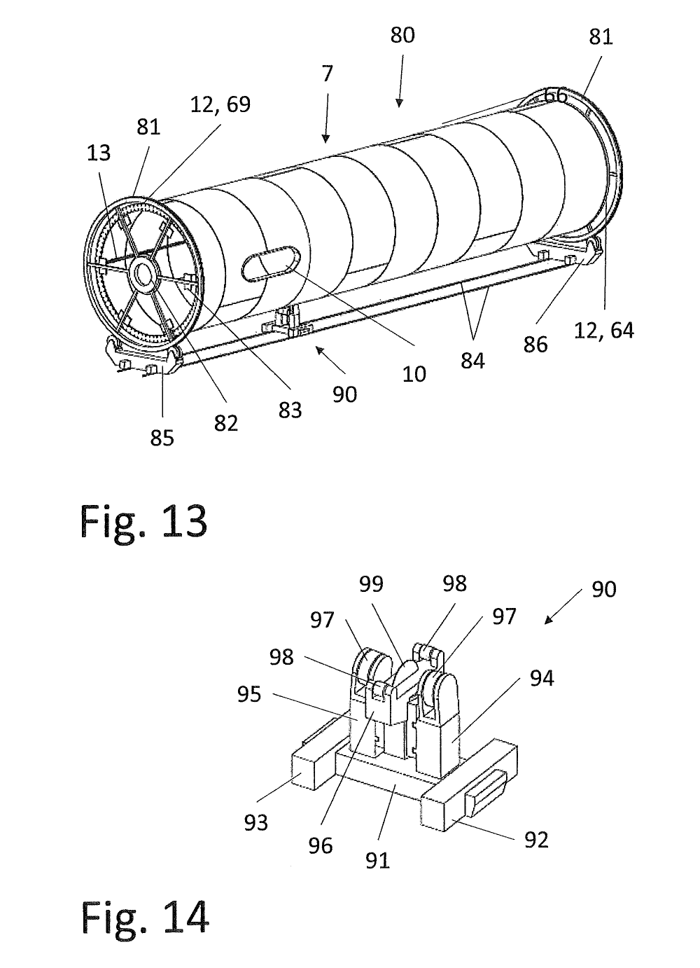

FIG. 13 shows an overall perspective view of a tower section 7 in a supporting device 80 for the lengthwise cutting of tower sections in their 6 o'clock position. The supporting device 80 includes two rotatable receiving wheels 81, which are supported by roller bearings 85, 86 running on rails 84, while the rollers of the roller bearings 85, 86 could be driven via electric motors. The rotatable receiving wheels 81 are each connected to an annular flange 12 at the end faces of the tower section 7, 8 directly or via an adapter plate 70. The receiving wheels 81 have a wheel hub 82, which is connected by spokes 83 to an outer ring. In one modification, not shown, the receiving wheels 81 may be rotatably mounted in the wheel hub 82 via mandrels instead of roller bearings 85, 86. On the rails 84 is arranged a cutting device 90 which can move via a feeding drive, with the travel of the cutting device 90 extending over the entire length of a tower section.

FIG. 14 shows a perspective view of the cutting device 90 for the lengthwise cutting of tower sections 7, 8 in the 6 o'clock position. The cutting device 90 includes a cutting tool 99, preferably configured as a side milling cutter or a saw blade. The cutting tool 99 is rotatably mounted in a vertically adjustable tool holder 96. The tool holder 96 furthermore includes guide rollers 98. On both sides of the cutting tool 99 and the tool holder 96 there are provided support rollers 97 along with support roller lifting devices 94, 95, which ensure a constant cutting depth of the cutting tool 99 in the material, especially in the tubular wall 38 of a tower section 7, 8. The tool holder 96 and the support roller lifting devices 94, 95 are held on a cross beam 91, which connects two driving frames 92, 93 for two feeding drives, not shown. The feeding drives actuate in synchronism the driving wheels which are guided on the rails 84.

One sample embodiment not shown has separate height-adjustable punches for lifting the tower section mounted in the supporting device in order to compensate for a buckling resulting from the force of gravity of the tower section mounted between its bearing points. In order to position the punches optimally in height—in the sense of a straight cutting line—at least one optical sensor is provided, which is connected to a control circuit for controlling the punch height. The cutting device 90 is mounted and guided movably on rails via at least one feeding drive. Thanks to the punches which are independent of the cutting device 90, the loading on the cutting device is considerably reduced, especially thanks to the force of gravity not needing to be supported. The cutting device according to this second sample embodiment can be more simple in configuration than the cutting device 90 in the sample embodiment of FIG. 13 and FIG. 14 on account of the functional separation; in particular, the support rollers 97 plus the support roller lifting devices 94, 95 shown there can be eliminated. Another advantage is that the feeding drives of the cutting device 90 only need to provide a power corresponding to the feeding/cutting force.

Another especially advantageous supporting device, not shown, has two spaced apart, horizontally arranged girders as a bearing bed for a tower section 7, 8 being machined, having slanting or concave receiving portions arranged in pairs. The spacing of the girders is larger than the greatest width of the cutting device, so that it can move freely on the rails beneath the tower section, the rails being preferably laid in a channel in the floor as a kind of subfloor. The cutting device can be driven by at least one feeding drive. This cutting device in turn can be more simple in configuration than the cutting device 90 of the sample embodiment in FIGS. 13 and 14; in particular, the support rollers 97 plus the support roller lifting devices 94, 95 shown there can be eliminated. Another advantage is that the feeding drives of the cutting device 90 only need to be configured for a power corresponding to the feeding/cutting force, since they do not need to overcome any supporting load component.

It is understood that the foregoing description is that of the preferred embodiments of the invention and that various changes and modifications may be made thereto without departing from the spirit and scope of the invention as defined in the appended claims.

### LIST OF REFERENCE SYMBOLS

1 Wind turbine
2 Tubular steel tower
3 Foundation
4 Nacelle
5 Rotor hub
6 Rotor blade
7, 8, 9 Tower section
10 Tower entrance door opening
11 Section separation
12 Annular flange
13 Longitudinal profile
18 Section segment
19 Separation line
21, 22, 23 Annular flange segment
28 Section piece
29 Borehole
31 Borehole
32, 36 Slot
33, 53 U-profile
33a, 33b Leg
33c, 53c Web
34a, 34b, 54a, 54b Welded seam
34c, 34d Welded seam
35 Fillet
37 Spacing element
38 Tubular wall
39 Connection means
39a Threaded bolt
39b Washer
39c Nut
40, 60 Through hole
43 H-profile
43a, 43b Leg
43c Web
44a, 44b, 44c, 44d Welded seam
46 Slot
61 Web
62, 67 Segment connection
63, 68 Slot
64 L-annular flange
65, 66 Leg
69 T-annular flange
70 Adapter plate
80 Machining station
81 Receiving wheel
82 Wheel hub
83 Spoke
84 Rail
85, 86 Roller bearing
90 Separating device
91 Cross beam
92, 93 Driving frame
94, 95 Support roller lifting device
96 Tool holder
97 Support roller
98 Guide roller
99 Cutting tool

What is claimed is:

1. A steel tower for a wind turbine, wherein the steel tower defines a longitudinal tower direction and a circumferential direction, the steel tower comprising:
a plurality of tower sections in the longitudinal direction;
each of said tower sections being either conical or cylindrical;
at least one of said tower sections being divided in the circumferential direction into at least two section segments;
each two mutually adjacent ones of said section segments defining a segment boundary therebetween;
a longitudinal profile extending in the longitudinal tower direction;
two mutually adjacent ones of said section segments being joined together by portions of said longitudinal profile;
said longitudinal profile including two legs;
each of said two mutually adjacent ones of said section segments having one of said legs of said longitudinal profile fastened thereto;
said legs of said two mutually adjacent ones of said section segments being joined to each other across the segment boundary corresponding thereto;
each of said legs of said two mutually adjacent ones of said section segments being arranged on a different side of the segment boundary corresponding thereto;
each of said legs of said two mutually adjacent ones of said section segments including a web section extending up to said respective segment boundary; and,
said web sections and said legs of said longitudinal profile forming a monolithic longitudinal profile prior to a severing of said two mutually adjacent ones of said section segments.

2. The steel tower as claimed in claim 1, wherein said web sections each have a separation section at their mutually facing sides.

3. A steel tower for a wind turbine, wherein the steel tower defines a longitudinal tower direction and a circumferential direction, the steel tower comprising:
a plurality of tower sections in the longitudinal direction;
each of said tower sections being either conical or cylindrical;
at least one of said tower sections being divided in the circumferential direction into two or more section segments;
each two mutually adjacent ones of said section segments defining a segment boundary therebetween;
a longitudinal profile extending in the longitudinal tower direction;
two mutually adjacent ones of said section segments being joined together by portions of said longitudinal profile;
said longitudinal profile including two legs;
each of said two mutually adjacent ones of said section segments having one of said legs of said longitudinal profile fastened thereto;
each of said legs of said two mutually adjacent ones of said section segments being arranged on a different side of the segment boundary corresponding thereto;
each of said legs of said two mutually adjacent ones of said section segments having a separation section directed toward the segment boundary corresponding thereto on their mutually facing sides; and,
said legs with said separation sections forming a monolithic longitudinal profile prior to a severing of said two mutually adjacent ones of said section segments.

4. The steel tower of claim 1, wherein:
said at least one of said tower sections has at least two section pieces;
said section pieces are welded together along their adjacent horizontal end faces and are welded to horizontal annular flanges along a free uppermost end face and along a free lowermost end face; and,
said annular flanges being divided at predetermined positions into at least two annular flange segments.

5. The steel tower of claim 1, wherein:
said at least one of said tower sections has at least two section pieces;
said section pieces are welded together along their adjacent horizontal end faces and are welded to horizontal annular flanges along a free uppermost and along a free lowermost end face; and,
said annular flanges being divided at predetermined positions into three annular flange segments.

6. The steel tower of claim 1, wherein:
each section segment defines a respective upper end face and a respective lower end face;
each section segment of said at least one tower section has at least one upper annular flange segment and one lower annular flange segment at said respective upper end face and said respective lower end face; and,
said upper annular flange segment and said lower annular flange segment define a plurality of through holes for a connector.

7. The steel tower of claim 1, wherein said monolithic longitudinal profile is a U-profile, H-profile, C-profile, I-profile, cap profile or a double-T profile.

8. The steel tower of claim 6, wherein:
said monolithic longitudinal profile has a web which includes said web sections; and,
said web has an outward directed fillet in the longitudinal tower direction.

9. The steel tower of claim 1, wherein said monolithic longitudinal profile, prior to the severing of said section segments, has a profile body with a groove facing away from a tower wall and, after the severing of said section segments, said profile body has two separate legs, which have a separation section on their mutually facing sides, and, said separation section is formed during the mutual severing of said section segments and said profile body.

10. The steel tower of claim 1, wherein:
said monolithic longitudinal profile, at each outwardly oriented transitions of its legs, has a bevel in the longitudinal tower direction configured to accommodate a welded seam.

11. The steel tower of claim 1, wherein:
the steel tower includes a plurality of monolithic longitudinal profiles; and,
said monolithic longitudinal profiles are welded in parallel to each other and the number of parallel longitudinal profiles is equal to the number of the section segments of a tower section.

12. The steel tower of claim 4, wherein:
said longitudinal profile has a length; and,
wherein for at least one of said two section pieces said length of said longitudinal profiles in the longitudinal tower direction is greater than a length of said at least one section piece.

13. The steel tower of claim 1, wherein at least one of said section segments of at least one of said tower sections is provided with preinstalled built-in elements.

14. A method for making a steel tower for a wind turbine, the method comprising the steps of:
making several tower sections, which can be arranged one on top of another in a longitudinal tower direction, each of the several tower sections being either conical or cylindrical;
defining at least two planned separation lines running in the longitudinal tower direction for one of the tower sections and providing a longitudinal profile for the planned separation line, having two legs running parallel and at a distance from each other, wherein the longitudinal profile is formed as a single piece with its legs so as to form a monolithic longitudinal profile;
connecting the longitudinal profile to the tower section, wherein the legs are connected to the tower section on opposite sides of the separation line;
severing the tower section along the separation line into section segments separated from each other by a segment boundary, wherein the monolithic longitudinal profile is also severed and each of the legs remains connected to a section segment on a different side of the segment boundary;
connecting two or more section segments by the legs of the severed longitudinal profile to a tower section; and, connecting several tower sections in the longitudinal tower direction to form a steel tower.

15. The method of claim 14, wherein the monolithic longitudinal profile has two legs running parallel to each other and joined together by a web, wherein the web is also severed during the severing of the tower section.

16. The method of claim 14, wherein the longitudinal profile prior to the severing of the section segments has a profile body with a groove arranged on a side facing away from a tower wall and after the severing of the section segments the longitudinal profile has two legs, which have a separation section on their mutually facing sides, which has been formed during the mutual severing of the section segments and the longitudinal profile.

17. The method of claim 14, wherein the tower section is placed via a hoist or an industrial truck above at least one movable cutting device and set down on a support such that the first planned separation line is positioned in a 6 o'clock position.

18. The method of claim 14 further comprising the step of welding a closed annular flange disposed in a predetermined position with respect to the circumferential direction for the forming of a tower section onto at least one of the tower section and one end surface of a section piece, the annular flange having a reduced cross section at predetermined positions and the predetermined positions coinciding with the planned separation lines of the tower section.

19. The method of claim 18 further comprising the steps of:
connecting each closed annular flange at the end face to a receiving wheel; and,
rotating the tower section into a desired position via the receiving wheels.

20. The method of claim 14 further comprising the step of placing the tower section onto a supporting device with two bearing regions spaced apart from each other via a hoist or an industrial truck, the tower section being positioned such that the first planned separation line runs between bearing regions in a 6 o'clock position.

21. The method of claim 14 further comprising the step of moving at least one movable cutting device into a starting position near a first annular flange; and, after moving at least one movable cutting device into the starting position, bringing a cutting tool into contact with the first annular flange at a first predetermined position via a vertically movable tool holder.

22. The method of claim 21, wherein the first annular flange is severed via the cutting tool at a first predetermined position with a reduced cross section and immediately thereafter the cutting tool is moved continuously along the first separation line through a tubular wall as well as the longitudinal profile connected to the tubular wall.
